(19) United States
(12) Patent Application Publication
(10) Pub. No.: US 2002/0084957 A1
(43) Pub. Date: Jul. 4, 2002

(54) Dither method and device for an image display

(76) Inventor: Nebojsa Fisekovic, Eindhoven (NL)

Correspondence Address: U.S. Philips Corporation, 580 White Plains Road, Tarrytown, NY, 10591, US

(21) Appl. No.: 10/014,197

(22) Filed: Nov. 13, 2001

(30) Foreign Application Priority Data
Nov. 13, 2000 (EP) 00203977.4

(51) Int. Cl. G09G 3/28

(52) U.S. Cl. 345/63

(57) ABSTRACT

A dithering method converts an input pixel value of n+k bits into an output pixel value of n bits by truncating k bits. The truncated part of k bits is compared with a pseudo random number. If the value of the k bits is larger than or equal to the value of the pseudo random number, than the output pixel value is made equal to 1 plus the input value of the n bits.

The invention relates to a dithering method of converting an input pixel value into an output pixel value.

The invention further relates to a device for converting an input pixel value into an output pixel value.

The invention further relates to an image display apparatus comprising such a device.

The problem that more bits are available for colour reproduction than can be used by a display is known. A large number of dither algorithms have been designed for diverse purposes and devices. The best known are Floyd-Steinberg, Error Diffusion, Dispersed Dither, Cluster Dither. A dither method and device are likewise known from the U.S. Pat. No. 5,479,594.

The known dither algorithms are usually (too) complex, particularly in respect of hardware resources such as memory for temporary storage of data. Such resources entail costs which are undesirable.

Many dither algorithms further have problems such as blurred edges and visible deterministic patterns, generally because of the fact that they act on whole frames or fields or at least on a part thereof viz. a number of pixels.

It is an object of the invention to provide a method as described in the preamble which is simpler and faster than the known method. This object is achieved according the invention in a dithering method for converting an input pixel value into an output pixel value on the basis of a predetermined criterion, wherein the input pixel value comprises a larger number of n+k bits than the output pixel value n, and wherein the remaining truncated part of k bits is compared to a pseudo-random value and wherein the output pixel value is formed by 1 plus the input value of the n bits if the value of the k bits is greater than or equal to the pseudo-random value.

Since the present invention performs operations at pixel level, there are no blurred edges. In addition, the algorithm is extremely simple and therefore suitable for digital image processing at high rates of for instance 75 or 125 Hz, and a video rate of 200 MHz or more.

Although the present invention can be applied on all types of display, the problem occurs also in PDPs (Plasma Display Panels) and PALC displays (Plasma Addressed Liquid Crystal), where relatively few bits, for instance six for each color, are available to display a colour.

It is a further object of the invention to provide a device as described in the preamble which is simpler and faster than the known device. This object is achieved according to the invention in a device for dithering in an image processing device, comprising:

an input bus for input of an input pixel value of n+k bits;

a random number generator;

a comparator connected to the k bits of the input bus and the output of the random number generator; and

an adder for adding the n bits and the output of the comparator which has as output a digital 1 only if the value of the k bits is greater than or equal to the value obtained from random number generator.

A pseudo-random number generator is preferably reset by a vertical synchronization signal Vsinc, since the same pseudo-sequence is then applied for each image.

In order to obtain an extremely elegant, simple and inexpensive solution, the pseudo-random number generator is preferably formed by a counter, the outputs of which are connected to one of the inputs of the comparator in (more or less) random, though preselected sequence.

In some conditions a repetitive pattern could occur on large areas of the same colour in the obtained image. In order to avoid this, it is recommended to load a random value in the counter at the beginning of each line. Such a pseudo-random number can be obtained from a second counter which is reset by vertical synchronization signal Vsinc, while the horizontal synchronization signal is used to load the first counter.

Further advantages, features and details of the present invention will be elucidated in the light of the following description of preferred embodiments thereof with reference to the annexed drawings, in which:

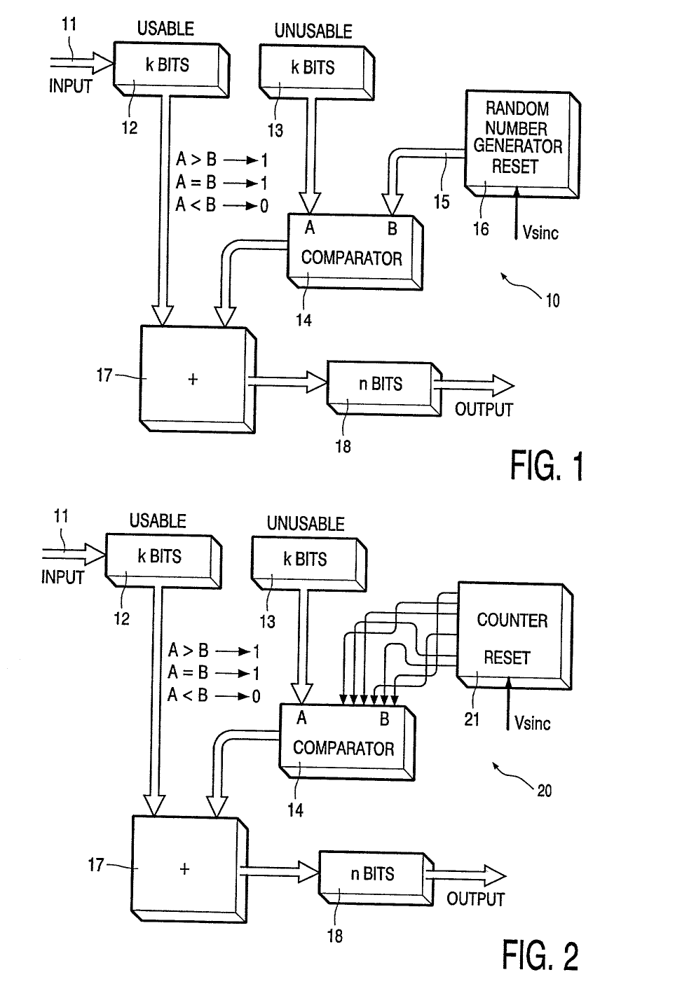

FIG. 1 shows a block diagram of a first preferred embodiment of a method and device according to the present invention;

FIG. 2 shows a block diagram of a second preferred embodiment of a device and method of the present invention; and

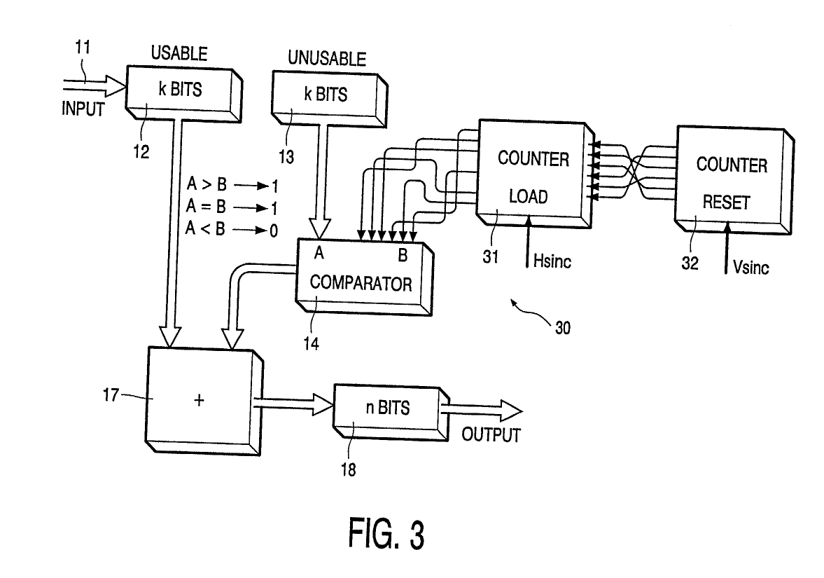

FIG. 3 shows a block diagram of a third preferred embodiment of a device and method of the present invention.

In a device 10 (FIG. 1) an input 11 is divided into a part of six (n) bits 12 and a truncated part of six (k) bits 13. Part 13 is compared in a comparator 14 with the outputs 15 of a pseudo-random generator 16. The pseudo-random generator 16 is reset by a vertical synchronization signal Vsinc of the image reproducing device.

The output of the comparator amounts to 1 if the input A of the comparator to which the k bits are connected is greater than or equal to the B input, i.e. the input provided by the random number generator. If B is greater than A, the output is 0. The output of comparator 14 is added to the n bits in adder 17, which therefore provides the outcome of a word 18 of n bits, which is either the same as the word 12 of n bits or increased by 1 depending on the operation in comparator 14.

The output word 18 is supplied to the input of a PALC display so that there is less problem with the truncation error and/or other artifacts which can occur in such an image.

Hardware resources are also extremely small in the embodiment of FIG. 2. The same reference numerals as in FIG. 1 are used as far as possible in this figure. In the device 20 according to FIG. 2 the outputs of a counter 21 are connected to the B input of comparator 14, while on the counter the vertical synchronization signal Vsinc is connected to the reset input thereof. The number of registers required for such a counter are practically always available in already present hardware. The outputs d0-d5 of counter 21 are fed to comparator 14 as B input with pseudo-random value in the sequence of for instance d(0), d(3), d(1), d(5), d(4), d(2), of course other sequences are also feasible.

In the embodiment 30 according to FIG. 3, in which the same components are designated as far as possible with the same reference numerals, two counters 31 and 32 are connected to each other in series. Counter 31 is connected to the input B of comparator 14 in the same manner as counter 21 of FIG. 2. A load input of counter 31 is connected to the horizontal synchronization signal Hsinc, so that when triggered by Hsinc a pseudo-random number of a second counter 32 is used as start counting value for the count of counter 31. A vertical synchronization signal Vsinc is connected to the reset input of counter 32.

The preferred embodiment of FIG. 3 has the additional advantage that if the horizontal resolution of the display which can be given as P×2 exp(k), wherein P is an integer, and k is equal to or approximates the count output of the counter, a repeating pattern which could be visible on large areas of the same colour can appear in the obtained image. This is avoided in that a random value is loaded into the counter 31 at the start of each line.

The algorithm according to the present invention has been implemented with good results on a PALC display experimental board with an Altera Flex 10K50 E integrated circuit from the Altera compay with 12 bits input data, while the PALC display can only display 6 bits.

The present invention is not limited to the above described preferred embodiment thereof, the rights sought being defined by the following claims, within the scope of which many modifications can be envisaged.

1. Dithering method for converting an input pixel value into an output pixel value on the basis of a predetermined criterion, wherein the input pixel value comprises a larger number of n+k bits than the output pixel value n, and wherein the remaining truncated part of k bits is compared to a pseudo-random value and wherein the output pixel value is formed by 1 plus the input value of the n bits if the value of the k bits is greater than or equal to the pseudo-random value.

2. Dithering method as claimed in claim 1, wherein the output pixel value is connected to an input of a PALC display.

3. Dithering method as claimed in claim 1, wherein the output pixel value is connected to an input of a plasma display panel.

4. Dithering method as claimed in claim 1, wherein n amounts to 6 or 8 and k is 4 or 6.

5. Device (10) for performing the method as claimed in any of the claims 1-4.

6. Device (10) for dithering in an image processing device, comprising:
an input bus (11) for input of an input pixel value of n+k bits;
a random number generator (16);
a comparator connected (14) to the k bits of the input bus and the output of the random number generator; and
an adder (17) for adding the n bits and the output of the comparator which has as output a digital 1 if the value of the k bits is greater than or equal to the random number generator.

7. Device (10) as claimed in claim 5 or 6, wherein the reset input of the random number generator (16) is connected to the vertical synchronization signal Vsinc.

8. Device (20) as claimed in claim 6 or 7, wherein the random number generator (14) is formed by a counter (21), the outputs of which are connected in preselected sequence to the input of the comparator (14).

9. Device (30) as claimed in claim 7, 8 or 9, wherein the random number generator (14) is formed by two counters (31, 32), wherein the outputs of the second counter are connected to the comparator and the outputs of the first counter are connected in random sequence to the inputs of the second counter, wherein the vertical synchronization signal Vsinc is connected to a reset input of the first counter (32) and the horizontal synchronization signal Hsinc is connected to an input of the second counter (31).

10. An image display apparatus comprising a device (10) as claimed in any of the claims 5 to 9.
